(19) United States
(12) Patent Application Publication
(10) Pub. No.: US 2026/0330530 A1
(43) Pub. Date: Oct. 22, 2026

(54) OBJECT RECOMMENDATION METHOD AND APPARATUS, ELECTRONIC DEVICE, AND READABLE STORAGE MEDIUM

(71) Applicant: SHENZHEN XUMI YUNTU SPACE TECHNOLOGY CO., LTD., Shenzhen (CN)

(72) Inventor: Chao MENG, Shenzhen (CN)

(21) Appl. No.: 19/710,435

(22) Filed: Jun. 17, 2026

Related U.S. Application Data
(63) Continuation of application No. PCT/CN2026/078918, filed on Feb. 12, 2026.

(30) Foreign Application Priority Data
Feb. 19, 2025 (CN) 202510182931.6

(51) Int. Cl. G06Q 30/0601

(52) U.S. Cl. CPC G06Q 30/0631

(57) ABSTRACT

An object recommendation method is provided. The method includes: processing attribute data corresponding to a to-be-recommended object and user-side data to obtain extended data corresponding to the to-be-recommended object and user preference data; performing text encoding processing on the extended data and the user preference data to obtain an extended vector and a user preference vector; processing the extended vector and the user preference vector based on a gating mechanism to obtain a gating vector corresponding to the extended vector and a gating vector corresponding to the user preference vector; performing spatial alignment processing on the two gating vectors to obtain a target extended vector and a target user preference vector; determining a recommendation score based on the above data and vectors; and determining target object data based on the recommendation score and a predetermined recommendation score threshold, and transmitting the target object data.

### CROSS-REFERENCE TO RELATED APPLICATION

This application is a continuation of International Application No. PCT/CN2026/078918, filed on Feb. 12, 2026, which is based on and claims priority to Chinese Patent Application No. 202510182931.6, filed on Feb. 19, 2025 and titled “OBJECT RECOMMENDATION METHOD AND APPARATUS, ELECTRONIC DEVICE, AND READABLE STORAGE MEDIUM”, both of which are incorporated herein by reference in their entireties.

### FIELD

Embodiments of the present disclosure relate to, but are not limited to, the technical field of object recommendation, and in particular, relate to an object recommendation method and apparatus, an electronic device, and a readable storage medium.

### BACKGROUND

Object recommendation methods are widely applied in various fields such as e-commerce platforms, social media, and content delivery networks. A traditional object recommendation method mainly relies on historical behavior data of a user, an attribute feature of a to-be-recommended object, and a simple matching algorithm to predict a user's preference degree for a specific object and perform recommendations accordingly. However, when processing user-side data and to-be-recommended object data, the traditional recommendation method only performs shallow feature extraction, resulting in insufficient accuracy and personalization degree of a recommendation result. In matching user preferences with features of the to-be-recommended object, a conventional method typically employs fixed weight allocation or a simple similarity calculation, lacking a dynamic adjustment and an adaptive mechanism. In view of the above problems, a conventional solution in the prior art is to introduce more complex feature engineering to extract deep-level features from the user-side data and the to-be-recommended object data, and to utilize a machine learning algorithm to improve accuracy and a generalization capability of a recommendation model. Nevertheless, the complex feature engineering and machine learning algorithm increase computational complexity and model training costs, and still lack the effective dynamic adjustment and adaptive mechanism when processing the user preferences and features of the to-be-recommended object.

Therefore, it may be seen that a problem exists in the prior art where the recommendation result suffers from low accuracy and personalization degree due to insufficient depth in processing the user-side data and to-be-recommended object data, as well as the lack of the dynamic adjustment and adaptive mechanism.

### SUMMARY

In view of this, embodiments of the present disclosure provide an object recommendation method and apparatus, an electronic device, and a readable storage medium, to solve a problem in the prior art where a recommendation result suffers from low accuracy and personalization degree due to insufficient depth in processing user-side data and to-be-recommended object data, as well as the lack of a dynamic adjustment and an adaptive mechanism.

In a first aspect of the embodiments of the present disclosure, an object recommendation method is provided. The object recommendation method includes: processing attribute data corresponding to a to-be-recommended object and user-side data through a large language model, respectively, to obtain extended data corresponding to the to-be-recommended object and user preference data; performing text encoding processing on the extended data corresponding to the to-be-recommended object and the user preference data, respectively, to obtain an extended vector corresponding to the to-be-recommended object and a user preference vector; processing the extended vector corresponding to the to-be-recommended object and the user preference vector based on a gating mechanism, respectively, to obtain a gating vector corresponding to the extended vector and a gating vector corresponding to the user preference vector; performing spatial alignment processing on the gating vector corresponding to the extended vector and the gating vector corresponding to the user preference vector, respectively, to obtain a target extended vector corresponding to the to-be-recommended object and a target user preference vector; determining a recommendation score corresponding to the to-be-recommended object based on the user-side data, the attribute data corresponding to the to-be-recommended object, historical interaction context data corresponding to the to-be-recommended object, the target user preference vector, and the target extended vector corresponding to the to-be-recommended object; and determining target object data based on the recommendation score corresponding to the to-be-recommended object and a predetermined recommendation score threshold, and transmitting the target object data to a target terminal device, to display the target object data on a current graphical user interface of the target terminal device.

In a second aspect of the embodiments of the present disclosure, an object recommendation apparatus is provided. The object recommendation apparatus includes: a first processing module configured to process attribute data corresponding to a to-be-recommended object and user-side data through a large language model, respectively, to obtain extended data corresponding to the to-be-recommended object and user preference data; a second processing module configured to perform text encoding processing on the extended data corresponding to the to-be-recommended object and the user preference data, respectively, to obtain an extended vector corresponding to the to-be-recommended object and a user preference vector; a third processing module configured to process the extended vector corresponding to the to-be-recommended object and the user preference vector based on a gating mechanism, respectively, to obtain a gating vector corresponding to the extended vector and a gating vector corresponding to the user preference vector; a fourth processing module configured to perform spatial alignment processing on the gating vector corresponding to the extended vector and the gating vector corresponding to the user preference vector, respectively, to obtain a target extended vector corresponding to the to-be-recommended object and a target user preference vector; a determination module configured to determine a recommendation score corresponding to the to-be-recommended object based on the user-side data, the attribute data corresponding to the to-be-recommended object, historical interaction context data corresponding to the to-be-recommended object, the target user preference vector, and the target extended vector corresponding to the to-be-recommended object; and a fifth processing module configured to determine target object data based on the recommendation score corresponding to the to-be-recommended object and a predetermined recommendation score threshold, and transmit the target object data to a target terminal device, to display the target object data on a current graphical user interface of the target terminal device.

In a third aspect of the embodiments of the present disclosure, an electronic device is provided. The electronic device includes: a memory; a processor; and a computer program stored in the memory and executable on the processor. The processor, when executing the computer program, implements the steps of the object recommendation method as described above.

In a fourth aspect of the embodiments of the present disclosure, a readable storage medium is provided. The readable storage medium stores a computer program. The computer program, when executed by a processor, implements the steps of the object recommendation method as described above.

Compared with the prior art, the embodiments of the present disclosure achieve the following beneficial effects. By performing text generation processing on the attribute data corresponding to the to-be-recommended object and the user-side data through the large language model, respectively, it is possible to obtain user preference data containing user preference information by processing the user-side data, and to obtain extended data corresponding to the to-be-recommended object and containing relevant information of the to-be-recommended object by processing the attribute data corresponding to the to-be-recommended object. Further, the text encoding processing can be performed on the extended data corresponding to the to-be-recommended object and the user preference data to obtain the extended vector corresponding to the to-be-recommended object and the user preference vector. Gating processing can be performed on the extended vector corresponding to the to-be-recommended object and the user preference vector, respectively, to obtain the gating vector corresponding to the extended vector and the gating vector corresponding to the user preference vector. The spatial alignment processing can be performed on the gating vector corresponding to the extended vector and the gating vector corresponding to the user preference vector, respectively, to map the gating vector corresponding to the extended vector and the gating vector corresponding to the user preference vector to an object recommendation space for data alignment, obtaining the target extended vector corresponding to the to-be-recommended object and the target user preference vector. The recommendation score corresponding to the to-be-recommended object is determined based on the user-side data, the attribute data corresponding to the to-be-recommended object, the historical interaction context data corresponding to the to-be-recommended object, the target user preference vector, and the target extended vector corresponding to the to-be-recommended object. Subsequently, the target object data can be determined based on the recommendation score corresponding to the to-be-recommended object and the predetermined recommendation score threshold, and be transmitted to the current graphical user interface of the target terminal device for display. In this way, matching accuracy between the user preference information and attribute information of the to-be-recommended object is improved. Flexibility and adaptability of data processing are enhanced. Correlation and accuracy of a vector representation are improved through the gating mechanism and the spatial alignment processing. Personalization and precision of the recommendation result are enhanced.

### BRIEF DESCRIPTION OF THE DRAWINGS

In order to more clearly explain technical solutions according to the embodiments of the present disclosure, drawings used in the description of the embodiments or the prior art are briefly described below. Obviously, the drawings described below are merely some embodiments of the present disclosure. Based on these drawings, other drawings can be obtained by those skilled in the art without creative effort.

FIG. 1 is a schematic scenario diagram of an application scenario according to an embodiment of the present disclosure.

FIG. 2 is a schematic flowchart of an object recommendation method according to embodiment of the present disclosure.

FIG. 3 is a schematic structural diagram of an object recommendation apparatus according to an embodiment of the present disclosure.

FIG. 4 is a schematic structural diagram of an electronic device according to an embodiment of the present disclosure.

### DETAILED DESCRIPTION

For the purpose of explanation rather than limitation, specific details such as particular system architectures and techniques are set forth hereinafter to provide a thorough understanding of the embodiments of the present disclosure. However, it will be apparent to those skilled in the art that the present disclosure may be practiced in other embodiments without these specific details. In other cases, detailed descriptions of well-known systems, apparatuses, circuits, and methods are omitted to avoid unnecessary details that might hinder the description of the present disclosure.

It should be noted that user information (that includes, but is not limited to, terminal device information, user personal information, or the like) and data (that includes, but is not limited to, displayed data, analyzed data, or the like) involved in the present disclosure are all information and data authorized by a user or fully authorized by all relevant parties. Moreover, the technical solutions involved in the present disclosure are automatically processed by a trained object recommendation model.

An object recommendation method and apparatus according to the embodiments of the present disclosure will be described below in detail with reference to the accompanying drawings.

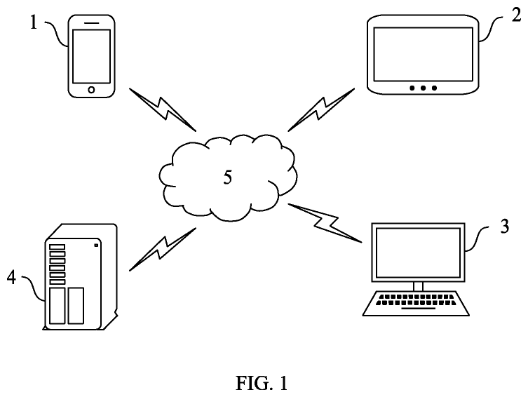

FIG. 1 is a schematic scenario diagram of an application scenario according to an embodiment of the present disclosure. The application scenario may include terminal devices 1, 2, and 3, a server 4, and a network 5.

The terminal devices 1, 2, and 3 may be either hardware or software. When the terminal devices 1, 2, and 3 are hardware, the terminal devices 1, 2, and 3 may be various electronic devices having a display screen and supporting communication with the server 4, which include, but are not limited to, smartphones, tablet computers, laptop computers, desktop computers, and the like. When the terminal devices 1, 2, and 3 are software, the terminal devices 1, 2, and 3 may be mounted in the above electronic devices. The terminal devices 1, 2, and 3 may be implemented as a plurality of software programs or software modules, or as a single software program or software module, which is not limited in the embodiments of the present disclosure. Further, various applications may be mounted on the terminal devices 1, 2, and 3, such as data processing applications, instant communication tools, social platform software, search applications, or shopping applications.

The server 4 may be a server providing various services, such as a background server configured to receive a request transmitted by a terminal device establishing a communication connection with the background server. The background server may receive and analyze the request transmitted by the terminal device and generate a processing result. The server 4 may be a single server, a server cluster composed of several servers, or a cloud computing service center, which is not limited in the embodiments of the present disclosure.

It should be noted that the server 4 may be hardware or software. When the server 4 is hardware, the server 4 may be various electronic devices configured to provide various services for the terminal devices 1, 2, and 3. When the server 4 is software, the server 4 may be a plurality of software programs or software modules, or a single software program or software module for providing the terminal devices 1, 2, and 3 with various services. The embodiments of the present disclosure are not limited thereto.

The network 5 may be a wired network connected by coaxial cables, twisted-pair wires, and optical fibers, or a wireless network capable of realizing an interconnection between various communication devices without wiring, such as Bluetooth, Near Field Communication (NFC), or Infrared. The embodiments of the present disclosure are not limited thereto.

The user may establish a communication connection with the server 4 via the network 5 through the terminal devices 1, 2, and 3 to receive or transmit information. In an embodiment, the server 4 may obtain user-side data, attribute data corresponding to a to-be-recommended object, and historical interaction context data corresponding to the to-be-recommended object through the terminal devices 1, 2, and 3. Further, text generation processing may be performed on the attribute data corresponding to the to-be-recommended object and the user-side data through a large language model, respectively. User preference data containing user preference information may be obtained by processing the user-side data. Extended data corresponding to the to-be-recommended object and containing relevant information of the to-be-recommended object may be obtained by processing the attribute data corresponding to the to-be-recommended object. Further, text encoding processing may be performed on the extended data corresponding to the to-be-recommended object and the user preference data to obtain an extended vector corresponding to the to-be-recommended object and a user preference vector. Gating processing may be performed on the extended vector corresponding to the to-be-recommended object and the user preference vector, respectively, to obtain a gating vector corresponding to the extended vector and a gating vector corresponding to the user preference vector. Spatial alignment processing may be performed on the gating vector corresponding to the extended vector and the gating vector corresponding to the user preference vector, respectively, to map the gating vector corresponding to the extended vector and the gating vector corresponding to the user preference vector to an object recommendation space for data alignment, obtaining a target extended vector corresponding to the to-be-recommended object and a target user preference vector. A recommendation score corresponding to the to-be-recommended object is determined based on the user-side data, the attribute data corresponding to the to-be-recommended object, the historical interaction context data corresponding to the to-be-recommended object, the target user preference vector, and the target extended vector corresponding to the to-be-recommended object. Consequently, target object data may be determined based on the recommendation score corresponding to the to-be-recommended object and a predetermined recommendation score threshold, and may be transmitted to a current graphical user interface of a target terminal device for display.

It should be noted that specific types, quantities, and combinations of the terminal devices 1, 2, and 3, the server 4, and the network 5 may be adjusted according to actual requirements of the application scenario, which is not limited in the embodiments of the present disclosure.

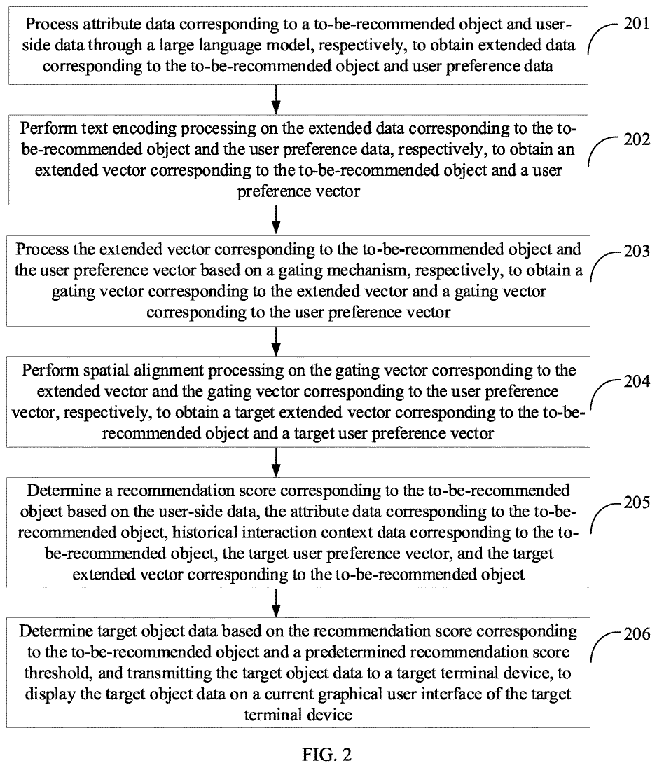

FIG. 2 is a schematic flowchart of an object recommendation method according to an embodiment of the present disclosure. The object recommendation method shown in FIG. 2 may be executed by the server shown in FIG. 1. As shown in FIG. 2, the object recommendation method includes following steps S201 to S206.

At step 201, attribute data corresponding to a to-be-recommended object and user-side data are processed through a large language model, respectively, to obtain extended data corresponding to the to-be-recommended object and user preference data.

In an embodiment, text generation processing may be performed on the attribute data corresponding to the to-be-recommended object and the user-side data through a pre-trained large language model to obtain the extended data corresponding to the to-be-recommended object and the user preference data. The user-side data may be attribute data of the user, which includes, but is not limited to, terminal-device input information and/or historical behavior information of the user. The attribute data corresponding to the to-be-recommended object may include description, price, category, and/or user reviews of the to-be-recommended object, which is not limited herein. The user preference data may contain information related to user's interests and needs. The extended data corresponding to the to-be-recommended object may be an enrichment and expansion of attribute information of the to-be-recommended object, which includes, but is not limited to, historical interaction information, award-winning information, and/or release information of the to-be-recommended object. In this way, a personalization degree of the object recommendation model is enhanced, accuracy of a recommendation result is improved, and precision of matching user needs with object attributes is elevated.

The large language model may be a deep learning model trained based on a large-scale corpus, and is capable of processing and understanding complex text information. The user-side data may refer to a data set related to user behaviors and attributes, and may be used to characterize terminal-device input information and/or historical behavior information of the user, which is not limited herein. The to-be-recommended object may refer to an object to be recommended to the user, which includes, but is not limited to, a commodity, a text, a video, or an image. The attribute data corresponding to the to-be-recommended object may refer to data used to characterize the features and attributes of the to-be-recommended object, such as specifications, prices, and/or reviews of a commodity. The user preference data may be obtained by processing the user-side data through the large language model, and may be used to characterize personalized needs and interests of the user. The extended data corresponding to the to-be-recommended object may be feature information obtained by processing the attribute data corresponding to the to-be-recommended object through the large language model, which includes, but is not limited to, the historical interaction information, award-winning information, and/or release information of the to-be-recommended object.

For example, in an e-commerce platform, the to-be-recommended object may be sports shoes. Then, the user-side data, such as terminal-device input information, search history, browsing records, and purchasing behavior of the user, may be processed through the large language model to obtain preference data of the user for sports shoes, such as brand preference, price range, and style preference. Meanwhile, attribute data of the sports shoe, such as material, weight, breathability, and user reviews, may be processed through the large language model to generate extended data corresponding to the sports shoe, including potential features like applicable scenarios and wearing comfort.

At step 202, text encoding processing is performed on the extended data corresponding to the to-be-recommended object and the user preference data, respectively, to obtain an extended vector corresponding to the to-be-recommended object and a user preference vector.

In an embodiment, the extended data corresponding to the to-be-recommended object and the user preference data may be processed through a text encoding model in Natural Language Processing (NLP), which includes, but is not limited to, a Word2Vec or Bidirectional Encoder Representations from Transformers (BERT) model, to convert text information into a numerical vector in a high-dimensional vector space, thereby obtaining the extended vector corresponding to the to-be-recommended object and the user preference vector. The user preference vector may be a numerical vector obtained through text encoding processing, and may be used to characterize the interest, preference, or demand information of the user. The extended vector corresponding to the to-be-recommended object may be a numerical vector extracted and encoded based on the extended data corresponding to the to-be-recommended object. In this way, matching accuracy between user preferences and the to-be-recommended object is enhanced, and the personalization degree of the object recommendation model is improved. Through the text encoding processing, unstructured text data is converted into a structured numerical vector, enabling a recommendation algorithm to analyze data more effectively and improving the accuracy of the recommendation result.

For example, in the e-commerce platform, the user preference data may include terminal-device input information, browsing history, purchase records, and search keywords of the user. The extended data corresponding to the to-be-recommended object may include a title, a description, and/or user reviews of the commodity. Through the text encoding processing, the aforementioned text data may be converted into a corresponding numerical vector, i.e., the extended vector corresponding to the to-be-recommended object and the user preference vector.

At step 203, the extended vector corresponding to the to-be-recommended object and the user preference vector are processed based on a gating mechanism, respectively, to obtain a gating vector corresponding to the extended vector and a gating vector corresponding to the user preference vector.

In an embodiment, nonlinear transformation processing may be performed on the extended vector corresponding to the to-be-recommended object and the user preference vector through the gating mechanism, to obtain the gating vector corresponding to the extended vector and the gating vector corresponding to the user preference vector, respectively. In this way, a dynamic adjustment capability of the object recommendation model is enhanced, enabling the object recommendation model to adjust its attention focus for different users and to-be-recommended objects. The accuracy and personalization degree of the object recommendation model are improved, and robustness and adaptability of the object recommendation model are enhanced.

The gating mechanism may be a network structure used to control information flow. The gating mechanism may determine information to be retained, discarded, or modified through a learned weight.

The gating vector corresponding to the user preference vector may be a vector obtained by processing the user preference vector through the gating mechanism, and may be used to characterize identification and emphasis of information in user preferences by the object recommendation model.

The gating vector corresponding to the extended vector may be a vector obtained by processing the extended vector of the to-be-recommended object through the gating mechanism, and may be used to characterize identification and emphasis of information in object features by the object recommendation model.

For example, in commodity recommendation on the e-commerce platform, the gating mechanism may be utilized to determine a gating vector corresponding to a user preference vector or a commodity feature extended vector that is important for the recommendation result, thereby obtaining the gating vector corresponding to the extended vector and the gating vector corresponding to the user preference vector.

At step 204, spatial alignment processing is performed on the gating vector corresponding to the extended vector and the gating vector corresponding to the user preference vector, respectively, to obtain a target extended vector corresponding to the to-be-recommended object and a target user preference vector.

In an embodiment, the spatial dimension alignment processing may be performed on the gating vector corresponding to the extended vector and the gating vector corresponding to the user preference vector through an attention mechanism, matrix multiplication, or other manners, which is not limited herein, to obtain the target extended vector corresponding to the to-be-recommended object and the target user preference vector. In this way, correlation between the user preference information and feature information of the to-be-recommended object is enhanced, the personalization degree of the object recommendation model is improved, and the accuracy of the object recommendation result is increased.

The target user preference vector may be a vector representation obtained by performing the spatial alignment processing on the gating vector corresponding to the user preference vector, and may be used to characterize personal interest and preference information of the user.

The target extended vector corresponding to the to-be-recommended object may be a vector representation obtained by performing the spatial alignment processing on the gating vector corresponding to the extended vector, enabling the target extended vector corresponding to the to-be-recommended object and the target user preference vector to be aligned in a same spatial dimension.

For example, in a recommendation system on the e-commerce platform, the user preference vector may include preference information of the user regarding commodity types, prices, and brands. The extended vector corresponding to the commodity may include attribute information such as a description, user reviews, and sales volume of the commodity. Through the spatial alignment processing, a vector representation corresponding to extended information of the commodity and a vector representation corresponding to overall preference information of the user, i.e., the target extended vector corresponding to the to-be-recommended object and the target user preference vector, are obtained.

At step 205, a recommendation score corresponding to the to-be-recommended object is determined based on the user-side data, the attribute data corresponding to the to-be-recommended object, historical interaction context data corresponding to the to-be-recommended object, the target user preference vector, and the target extended vector corresponding to the to-be-recommended object.

In an embodiment, a recommendation score of the to-be-recommended object for target user may be calculated and determined by a Multilayer Perceptron (MLP) based on the user-side data, the attribute data corresponding to the to-be-recommended object, the historical interaction context data corresponding to the to-be-recommended object, the target user preference vector, and the target extended vector corresponding to the to-be-recommended object. The historical interaction context data corresponding to the to-be-recommended object includes, but is not limited to, information such as time, location, and environment of historical interactions between the user and the to-be-recommended object. In this way, the personalization degree of the object recommendation model is enhanced, and accuracy and relevance of the recommendation result are improved. By comprehensively considering multiple data sources and features, the recommendation result is made more in line with actual needs of the user.

The recommendation score corresponding to the to-be-recommended object may be a quantitative index, and may be used to characterize attractiveness and recommendation value of the to-be-recommended object for the user. The recommendation score may be obtained by processing features such as the user-side data, the attribute data corresponding to the to-be-recommended object, the historical interaction context data, the target user preference vector, and the target extended vector corresponding to the to-be-recommended object through the MLP. The recommendation score may be used for sorting and filtering recommendation objects, as well as evaluating a recommendation effect or other aspects, which is not limited herein.

For example, in the e-commerce platform, when the user browses commodities, a recommendation score of a commodity for the user may be calculated based on user-side data such as terminal-device input information, browsing history, purchase records, and search keywords; attribute data such as category, price, brand, and sales volume of the commodity; and historical interaction context data such as time, location, and environment when the user purchased the commodity, combined with the user preference vector and a commodity extended vector.

At step 206, target object data is determined based on the recommendation score corresponding to the to-be-recommended object and a predetermined recommendation score threshold, and is transmitted to a target terminal device, to display the target object data on a current graphical user interface of the target terminal device.

In an embodiment, the recommendation score of the to-be-recommended object may be evaluated based on the predetermined recommendation score threshold (that may be a critical value comprehensively obtained based on factors such as business logic, user preferences, and data quality, and may be used to determine whether the to-be-recommended object is worthy of being recommended). When the recommendation score corresponding to the to-be-recommended object is greater than or equal to the predetermined recommendation score threshold, the to-be-recommended object data is determined as the target object data. When the recommendation score corresponding to the to-be-recommended object is smaller than the predetermined recommendation score threshold, the to-be-recommended object data is not the target object data. Subsequently, the target object data may be transmitted to the target terminal device. The target terminal device may be used to display the target object data on a currently displayed graphical user interface. The target terminal device may be a terminal device of the user, including but not limited to a smartphone, a tablet computer, or a computer, etc. The current graphical user interface may be an interface visible through the screen and interactive for the user. In this way, precision of the recommendation result is enhanced, and efficiency of obtaining useful information by the user and user experience are improved. Moreover, by setting the recommendation score threshold to filter the target object data, a time cost of filtering information by the user is reduced, and user's satisfaction with recommended content is increased.

The predetermined recommendation score threshold may be a score boundary used to determine whether the to-be-recommended object is the target object. When the recommendation score is greater than or equal to the predetermined recommendation score threshold, it may be determined that the to-be-recommended object is the target object data.

The target object data may be object data obtained through filtering, and the recommendation score of the target object data is greater than or equal to the predetermined recommendation score threshold. The target object data may be commodity information, text content, audio content, video content, or the like, which is not limited herein.

The target terminal device may be a device used to receive and display the target object data. The target terminal device may be a smart device that the user is using or is about to use, including a mobile phone, a tablet computer, a computer, or the like, which is not limited herein.

The current graphical user interface may be an interface displayed on the screen and allowing user interaction when the user is using the target terminal device. The current graphical user interface may contain various information elements, including but not limited to text, pictures, videos, and/or operation buttons, etc. The current graphical user interface may be used to realize information exchange and operation control between the user and the target terminal device.

For example, in the e-commerce platform, a recommendation score of a to-be-recommended commodity is 90. Based on the predetermined recommendation score threshold, such as 80 points, since 90 is greater than 80, it may be determined that the to-be-recommended commodity is a target commodity. Subsequently, when the user opens an application of the e-commerce platform, data of the target commodity may be transmitted to the user's mobile phone, and the target commodity may be displayed on a current graphical user interface of the mobile phone.

With the technical solution according to the embodiments of the present disclosure, by performing the text generation processing on the attribute data corresponding to the to-be-recommended object and the user-side data through the large language model, it is possible to obtain the user preference data containing the user preference information by processing the user-side data, and to obtain the extended data corresponding to the to-be-recommended object and containing the relevant information of the to-be-recommended object by processing the attribute data corresponding to the to-be-recommended object. Further, the text encoding processing may be performed on the extended data corresponding to the to-be-recommended object and the user preference data to obtain the extended vector corresponding to the to-be-recommended object and the user preference vector. The gating processing may be performed on the extended vector corresponding to the to-be-recommended object and the user preference vector, respectively, to obtain the gating vector corresponding to the extended vector and the gating vector corresponding to the user preference vector. The spatial alignment processing may be performed on the gating vector corresponding to the extended vector and the gating vector corresponding to the user preference vector, respectively, to map the gating vector corresponding to the extended vector and the gating vector corresponding to the user preference vector to the object recommendation space for data alignment, obtaining the target extended vector corresponding to the to-be-recommended object and the target user preference vector. The recommendation score corresponding to the to-be-recommended object is determined based on the user-side data, the attribute data corresponding to the to-be-recommended object, the historical interaction context data corresponding to the to-be-recommended object, the target user preference vector, and the target extended vector corresponding to the to-be-recommended object. Subsequently, the target object data may be determined based on the recommendation score corresponding to the to-be-recommended object and the predetermined recommendation score threshold, and be transmitted to the current graphical user interface of the target terminal device for display. In this way, matching accuracy between the user preference information and the attribute information of the to-be-recommended object is improved. Flexibility and adaptability of data processing are enhanced. Correlation and accuracy of the vector representation are improved through the gating mechanism and the spatial alignment processing. Personalization and precision of the recommendation result are enhanced.

In some embodiments, the processing the attribute data corresponding to the to-be-recommended object and the user-side data through the large language model, respectively, to obtain the extended data corresponding to the to-be-recommended object and the user preference data includes: processing the user-side data based on a predetermined preference generation template to obtain user-side templated data; processing the attribute data corresponding to the to-be-recommended object based on a predetermined extension generation template to obtain templated attribute data corresponding to the to-be-recommended object; and processing the templated attribute data corresponding to the to-be-recommended object and the user-side templated data through the large language model, respectively, to obtain the extended data corresponding to the to-be-recommended object and the user preference data.

In an embodiment, the user-side data may be subjected to structured processing through the predetermined preference generation template, and is configured to a corresponding position of the predetermined preference generation template, to obtain the user-side templated data. The structured processing may be performed on the attribute data of the to-be-recommended object through the predetermined extension generation template to obtain the templated attribute data of the to-be-recommended object. Subsequently, the templated attribute data corresponding to the to-be-recommended object and the user-side templated data may be inputted into the large language model for text generation processing to obtain the extended data corresponding to the to-be-recommended object and the user preference data.

The predetermined preference generation template may be a prompt engineering framework used to convert the user-side data into structured template data. The predetermined preference generation template may be used to define a rule for extracting target information from original user data, and organize the extracted target information into a format suitable for processing by the large language model.

The user-side templated data may be structured data obtained after processing the user-side data by applying the predetermined preference generation template.

The predetermined extension generation template may be a prompt engineering framework used to convert the attribute data corresponding to the to-be-recommended object into structured template data. The predetermined extension generation template may be used to define a rule for extracting target information from original attribute data, and organize the extracted target information into a format suitable for processing by the large language model.

The templated attribute data corresponding to the to-be-recommended object may be structured data obtained after processing the attribute data corresponding to the to-be-recommended object by applying the predetermined extension generation template.

For example, in the e-commerce platform, the user-side data includes terminal-device input information, browsing records, purchase records, search keywords, or the like of the user. The to-be-recommended object may be a to-be-recommended commodity on the platform. The user-side data may be converted into templated data through the predetermined preference generation template, such as converting the user's browsing records into a form of “the user browsed {commodity category}”. The attribute data corresponding to the to-be-recommended commodity may be converted into the templated data through the predetermined extension generation template, such as converting description information of the to-be-recommended commodity into a form of “{commodity name} is {commodity category} and has {features}”. Then, the aforementioned templated data may be inputted into the large language model for text generation processing to obtain extended data corresponding to the to-be-recommended commodity and the user preference data.

With the technical solution according to the embodiments of the present disclosure, the user-side data is subjected to the structured processing through the predetermined preference generation template, and configured to the corresponding position of the predetermined preference generation template to obtain the user-side templated data. The structured processing may be performed on the attribute data of the to-be-recommended object through the predetermined extension generation template to obtain the templated attribute data of the to-be-recommended object. Then, the templated attribute data corresponding to the to-be-recommended object and the user-side templated data may be inputted into the large language model for text generation processing to obtain the extended data corresponding to the to-be-recommended object and the user preference data. In this way, a degree of data structuring is enhanced. Efficiency and accuracy of data processing are improved. A personalized recommendation capability of the object recommendation model is enhanced.

In some embodiments, the determining the recommendation score corresponding to the to-be-recommended object based on the user-side data, the attribute data corresponding to the to-be-recommended object, the historical interaction context data corresponding to the to-be-recommended object, the target user preference vector, and the target extended vector corresponding to the to-be-recommended object includes: performing splicing processing on the target extended vector corresponding to the to-be-recommended object and the target user preference vector to obtain a recommendation enhancement vector; performing feature extraction processing on the user-side data, the attribute data corresponding to the to-be-recommended object, and the historical interaction context data corresponding to the to-be-recommended object to obtain a user-side vector, an attribute vector corresponding to the to-be-recommended object, and a historical interaction context vector corresponding to the to-be-recommended object; performing vector merging processing on the recommendation enhancement vector, the user-side vector, the attribute vector corresponding to the to-be-recommended object, and the historical interaction context vector corresponding to the to-be-recommended object to obtain a target vector corresponding to the to-be-recommended object; and determining the recommendation score corresponding to the to-be-recommended object based on the target vector corresponding to the to-be-recommended object.

In an embodiment, the target extended vector corresponding to the to-be-recommended object and the target user preference vector may be spliced to obtain the recommendation enhancement vector. The splicing may be implemented through direct splicing, dimension matching splicing, linear transformation splicing, or other manners, which is not limited herein. The feature extraction may be performed on the user-side data, the attribute data corresponding to the to-be-recommended object, and the historical interaction context data corresponding to the to-be-recommended object, respectively, to obtain the user-side vector, the attribute vector corresponding to the to-be-recommended object, and the historical interaction context vector. The feature extraction may be implemented through a convolutional neural network, word embedding, a recurrent neural network, or other manners, which is not limited herein. Further, the above vectors may be processed through weighted merging, nonlinear merging, or other manners to obtain the target vector corresponding to the to-be-recommended object, which is not limited herein. The recommendation score corresponding to the to-be-recommended object may be calculated based on the target vector corresponding to the to-be-recommended object. For example, the recommendation score corresponding to the to-be-recommended object may be calculated through dot commodity, cosine similarity, Euclidean distance, or other manners.

The recommendation enhancement vector may be a vector obtained by splicing the target extended vector corresponding to the to-be-recommended object and the target user preference vector. The recommendation enhancement vector may be used to characterize preference information of the user and extended information of the to-be-recommended object. The splicing may be implemented through direct splicing, dimension matching splicing, linear transformation splicing, or other manners, which is not limited herein.

The historical interaction context data corresponding to the to-be-recommended object may be historical context information when the user interacts with the to-be-recommended object, including but not limited to time, location, climate at that time, and/or user behavior, etc. The historical interaction context data corresponding to the to-be-recommended object may be obtained by recording and analyzing the historical behavior information of the user, and may be used to evaluate user's potential interest in the to-be-recommended object.

The user-side vector may be a vector obtained by performing the feature extraction processing on the user-side data. The user-side vector may be used to characterize feature information of the user, including but not limited to age, gender, and/or interest preferences of the user, and may be used to understand user needs and preferences.

The attribute vector corresponding to the to-be-recommended object may be a vector obtained by performing the feature extraction processing on the attribute data corresponding to the to-be-recommended object. The attribute vector corresponding to the to-be-recommended object may be used to characterize inherent attribute information of the to-be-recommended object, including but not limited to price, brand, and/or category of the to-be-recommended object, etc.

The historical interaction context vector corresponding to the to-be-recommended object may be a vector obtained by performing the feature extraction processing on the historical interaction context data corresponding to the to-be-recommended object. The historical interaction context vector corresponding to the to-be-recommended object may be used to characterize a context feature when the user historically interacts with the to-be-recommended object, including but not limited to behavior patterns at different times and locations of the user. The historical interaction context vector may be used to analyze changes in the user preferences for the to-be-recommended object under different contexts.

For example, in the e-commerce platform, when the user browses commodities, the recommendation enhancement vector may be obtained based on the user-side data such as the terminal-device input information, historical purchase records, browsing records, and search records of the user; attribute data of the commodity, such as the price, brand, and category; historical interaction context data between the commodity and the user, such as time, location, and weather when the user clicked or purchased the commodity; the user preference vector; and the commodity extended vector, such as sales volume and reviews of the commodity. Then, merging processing may be performed on the above vectors to obtain a target vector of the commodity, and a recommendation score of the to-be-recommended commodity may be calculated based on the target vector of the commodity.

With the technical solution according to the embodiments of the present disclosure, the target extended vector corresponding to the to-be-recommended object and the target user preference vector may be spliced to obtain the recommendation enhancement vector. The feature extraction processing may be performed on the user-side data, the attribute data corresponding to the to-be-recommended object, and the historical interaction context data corresponding to the to-be-recommended object, respectively, to obtain the user-side vector, the attribute vector corresponding to the to-be-recommended object, and the historical interaction context vector. Further, the above vectors may be processed through weighted merging or nonlinear merging to obtain the target vector corresponding to the to-be-recommended object. The recommendation score corresponding to the to-be-recommended object may be calculated based on the target vector corresponding to the to-be-recommended object. In this way, the personalization degree of the object recommendation model is enhanced, and the accuracy of the recommendation result and the user experience are improved.

In some embodiments, the determining the recommendation score corresponding to the to-be-recommended object based on the target vector corresponding to the to-be-recommended object includes: performing flattening processing on the target vector corresponding to the to-be-recommended object to obtain a target low-dimensional vector corresponding to the to-be-recommended object; performing mapping processing on the target low-dimensional vector corresponding to the to-be-recommended object through a multilayer perceptron to obtain a spatial mapping vector corresponding to the to-be-recommended object; and performing recommendation score calculation processing on the spatial mapping vector corresponding to the to-be-recommended object to obtain the recommendation score corresponding to the to-be-recommended object.

In an embodiment, the flattening processing may be performed on the target vector corresponding to the to-be-recommended object to reduce dimensionality of the target vector corresponding to the to-be-recommended object, obtaining the target low-dimensional vector corresponding to the to-be-recommended object. Nonlinear mapping processing may be performed on the target low-dimensional vector through the MLP to obtain the spatial mapping vector corresponding to the to-be-recommended object. The recommendation score calculation processing may be performed on the spatial mapping vector to obtain the recommendation score of the to-be-recommended object.

The target low-dimensional vector corresponding to the to-be-recommended object may be a low-dimensional representation obtained by performing the flattening processing on a high-dimensional target vector corresponding to the to-be-recommended object. The flattening processing may be implemented through a dimensionality reduction manner, such as Principal Component Analysis (PCA) or Singular Value Decomposition (SVD), which is not limited herein.

The MLP may be a feedforward artificial neural network model and be composed of an input layer, a plurality of hidden layers, and an output layer. Neurons in each layer are fully connected to neurons in the next layer, realizing a nonlinear mapping from input to output through a nonlinear activation function. The nonlinear activation function includes, but is not limited to, ReLU or sigmoid.

The spatial mapping vector corresponding to the to-be-recommended object may be a vector representation obtained by performing nonlinear transformation on the target low-dimensional vector through the MLP. This spatial mapping vector representation may be processed and obtained in the hidden layer or the output layer of the MLP.

For example, in the e-commerce platform, a target low-dimensional vector corresponding to the to-be-recommended commodity may be obtained through the flattening processing. The mapping processing may be performed on the target low-dimensional vector through the MLP to obtain a spatial mapping vector corresponding to the commodity. Then, a recommendation score corresponding to the to-be-recommended commodity may be calculated based on the spatial mapping vector.

With the technical solution according to the embodiments of the present disclosure, by performing the flattening processing on the target vector corresponding to the to-be-recommended object, the dimensionality of the target vector corresponding to the to-be-recommended object is reduced, to obtain the target low-dimensional vector corresponding to the to-be-recommended object. Then, the nonlinear mapping processing may be performed on the target low-dimensional vector through the MLP to obtain the spatial mapping vector corresponding to the to-be-recommended object. The recommendation score calculation process may be performed on the spatial mapping vector to obtain the recommendation score of the to-be-recommended object. In this way, a data processing capability of the object recommendation model is enhanced. The accuracy and precision of the recommendation result are improved. The user experience and satisfaction are improved.

In some embodiments, the processing the extended vector corresponding to the to-be-recommended object and the user preference vector based on the gating mechanism, respectively, to obtain the gating vector corresponding to the extended vector and the gating vector corresponding to the user preference vector includes: performing nonlinear transformation processing on the user preference vector to obtain a retention vector corresponding to the user preference vector; performing reset transformation processing on the retention vector corresponding to the user preference vector to obtain the gating vector corresponding to the user preference vector; performing nonlinear transformation processing on the extended vector corresponding to the to-be-recommended object to obtain a retention vector corresponding to the extended vector; and performing reset transformation processing on the retention vector corresponding to the extended vector to obtain the gating vector corresponding to the extended vector.

In an embodiment, the user preference vector may be processed through the nonlinear transformation. The nonlinear transformation may be implemented through a Sigmoid function or a ReLU function, which is not limited herein, to obtain the retention vector corresponding to the user preference vector. The retention vector retains target information of the user preferences. The retention vector may be further processed through reset transformation. The reset transformation may be implemented through a reset gate of the gating mechanism to obtain the gating vector corresponding to the user preference vector. The nonlinear transformation may be performed on the extended vector corresponding to the to-be-recommended object to obtain the retention vector corresponding to the extended vector. The retention vector may be used to characterize an important feature of the to-be-recommended object. Then, the retention vector corresponding to the extended vector may be processed through the reset gate to obtain the gating vector corresponding to the extended vector.

The retention vector corresponding to the user preference vector may be a vector obtained by processing the user preference vector through the nonlinear transformation. The retention vector corresponding to the user preference vector may be used to characterize the target information of the user preferences. The target information may be extracted through a nonlinear activation function in a neural network. The nonlinear activation function includes, but is not limited to, Sigmoid or ReLU.

The retention vector corresponding to the extended vector may be a vector obtained by processing the extended vector corresponding to the to-be-recommended object through the nonlinear transformation. The retention vector corresponding to the extended vector may be used to characterize a target feature of the to-be-recommended object. The target feature may be extracted through the nonlinear activation function in the neural network. The target feature may be used to evaluate a matching degree between the to-be-recommended object and the user preferences.

For example, in the e-commerce platform, the user preference vector may include encodings of information such as user preferences for commodity categories, price ranges, and brands. The extended vector of the to-be-recommended object may include encodings of information such as detailed commodity descriptions, user reviews, and sales volume. Through the nonlinear transformation, a retention vector corresponding to a commodity feature and the retention vector corresponding to the user preference vector may be extracted, respectively. The reset transformation is performed through the reset gate, to generate a gating vector corresponding to the commodity feature and the gating vector corresponding to the user preference vector.

With the technical solution according to the embodiments of the present disclosure, the user preference vector is processed through the nonlinear transformation to obtain the retention vector corresponding to the user preference vector. This retention vector retains the target information of the user preferences and may be further processed through the reset transformation to obtain the gating vector corresponding to the user preference vector. The nonlinear transformation may be performed on the extended vector corresponding to the to-be-recommended object to obtain the retention vector corresponding to the extended vector, which is then processed through the reset gate to obtain the gating vector corresponding to the extended vector. In this way, an expressive capability of the object recommendation model regarding the user preferences and a feature of the to-be-recommended object is enhanced, improving accuracy and flexibility of the object recommendation model.

In some embodiments, the performing the spatial alignment processing on the gating vector corresponding to the extended vector and the gating vector corresponding to the user preference vector, respectively, to obtain the target extended vector corresponding to the to-be-recommended object and the target user preference vector includes: performing dimension alignment processing on the gating vector corresponding to the extended vector and the gating vector corresponding to the user preference vector, respectively, to obtain a same-dimension vector corresponding to the extended vector and a same-dimension vector corresponding to the user preference vector; and performing spatial transformation processing on the same-dimension vector corresponding to the extended vector and the same-dimension vector corresponding to the user preference vector to obtain the target extended vector corresponding to the to-be-recommended object and the target user preference vector.

In an embodiment, the dimension alignment processing may be performed on the gating vector corresponding to the extended vector and the gating vector corresponding to the user preference vector, so that dimensions of the gating vector corresponding to the extended vector and the gating vector corresponding to the user preference vector are the same, thereby obtaining the same-dimension vector corresponding to the extended vector and the same-dimension vector corresponding to the user preference vector. The spatial transformation processing may then be performed on the same-dimension vector corresponding to the extended vector and the same-dimension vector corresponding to the user preference vector, respectively. The spatial transformation may be implemented through manners such as matrix multiplication or nonlinear transformation, which is not limited here. The same-dimension vector corresponding to the extended vector and the same-dimension vector corresponding to the user preference vector are mapped into a specified feature space to obtain the target extended vector corresponding to the to-be-recommended object and the target user preference vector.

The same-dimension vector corresponding to the user preference vector may be a vector obtained through the dimension alignment processing. The same-dimension vector corresponding to the extended vector and the same-dimension vector corresponding to the user preference vector have the same dimension. The same-dimension vector corresponding to the user preference vector may be obtained by adjusting the dimension of the gating vector corresponding to the user preference vector. The adjustment process may be implemented through manners such as padding, truncation, or mapping, which is not limited here.

The same-dimension vector corresponding to the extended vector may be a vector obtained through the dimension alignment processing. The same-dimension vector corresponding to the user preference vector and the same-dimension vector corresponding to the extended vector have the same dimension. The same-dimension vector corresponding to the extended vector may be obtained by adjusting the dimension of the gating vector corresponding to the extended vector.

For example, in an online shopping platform, the user preference vector may characterize a user preference feature for the commodity, such as price, brand, and/or color. The extended vector may characterize a detailed attribute of the to-be-recommended commodity, such as size, material, and/or reviews. By performing the dimension alignment processing and the spatial transformation processing on the gating vector corresponding to the extended vector and the gating vector corresponding to the user preference vector, a more precise target extended vector corresponding to the to-be-recommended object and a more precise target user preference vector may be obtained.

With the technical solution according to the embodiments of the present disclosure, the dimension alignment processing is performed on the gating vector corresponding to the extended vector and the gating vector corresponding to the user preference vector, so that the dimensions of the gating vector corresponding to the extended vector and the gating vector corresponding to the user preference vector are the same, thus obtaining the same-dimension vector corresponding to the extended vector and the same-dimension vector corresponding to the user preference vector. The spatial transformation processing may be performed on the same-dimension vector corresponding to the extended vector and the same-dimension vector corresponding to the user preference vector, respectively, to map the same-dimension vector corresponding to the extended vector and the same-dimension vector corresponding to the user preference vector into the specified feature space, to obtain the target extended vector corresponding to the to-be-recommended object and the target user preference vector. In this way, comparability between the extended vector corresponding to the to-be-recommended object and the user preference vector is enhanced, and the precision of the object recommendation model and the user experience are improved.

In some embodiments, the performing the spatial transformation processing on the same-dimension vector corresponding to the extended vector and the same-dimension vector corresponding to the user preference vector, respectively, to obtain the target extended vector corresponding to the to-be-recommended object and the target user preference vector includes: performing spatial rotation processing on the same-dimension vector corresponding to the user preference vector to obtain a spatial matching vector corresponding to the user preference vector; performing weight matching processing on the same-dimension vector corresponding to the extended vector to obtain a weighted vector corresponding to the extended vector; and performing alignment processing on the weighted vector corresponding to the extended vector and the spatial matching vector corresponding to the user preference vector to obtain the target extended vector corresponding to the to-be-recommended object and the target user preference vector.

In an embodiment, the spatial rotation processing may be performed on the same-dimension vector corresponding to the user preference vector to obtain a spatial matching vector that is more compatible with the MLP. The weight matching processing may be performed on the same-dimension vector corresponding to the extended vector, i.e., different weights are assigned based on the importances of respective dimensions, to obtain the weighted vector corresponding to the extended vector. Subsequently, the alignment processing may be performed on the weighted vector corresponding to the extended vector and the spatial matching vector corresponding to the user preference vector to obtain the target extended vector corresponding to the to-be-recommended object and the target user preference vector.

The spatial matching vector corresponding to the user preference vector may be a vector obtained by performing the spatial rotation processing on the same-dimension vector corresponding to the user preference vector.

The weighted vector corresponding to the extended vector may be a vector obtained by performing the weight matching processing on the same-dimension vector corresponding to the extended vector. The weight of each dimension may be used to represent the importances of that dimension in the recommendation.

For example, in the online shopping platform, the user preference vector may characterize user preference regarding dimensions such as commodity price, brand, color, and/or material. The extended vector may characterize additional information of the to-be-recommended commodity, such as sales volume, reviews, and/or new commodity labels. Through the spatial rotation processing, the same-dimension vector corresponding to the user preference vector may be converted into the spatial matching vector. Moreover, through the weight matching processing, the same-dimension vector corresponding to the extended vector may be weighted. Subsequently, the alignment processing may be performed on the weighted vector corresponding to the extended vector and the spatial matching vector corresponding to the user preference vector to obtain the target extended vector corresponding to the to-be-recommended object and the target user preference vector.

With the technical solution according to the embodiments of the present disclosure, the spatial rotation processing may be performed on the same-dimension vector corresponding to the user preference vector to obtain the spatial matching vector that is more compatible with the MLP, the weight matching processing may be performed on the same-dimension vector corresponding to the extended vector to obtain the weighted vector corresponding to the extended vector. Further, the alignment processing may be performed on the weighted vector corresponding to the extended vector and the spatial matching vector corresponding to the user preference vector, to obtain the target extended vector corresponding to the to-be-recommended object and the target user preference vector. In this way, correlation between the user preferences and the to-be-recommended object is enhanced, and the precision of the object recommendation model and the user experience are improved.

All of the aforementioned optional technical solutions may be combined arbitrarily to form optional embodiments of the present disclosure, and details thereof are omitted herein.

The apparatus embodiments of the present disclosure will be described below, which may be used to execute the method embodiments of the present disclosure. For details not disclosed in the apparatus embodiments of the present disclosure, reference may be made to the method embodiments of the present disclosure.

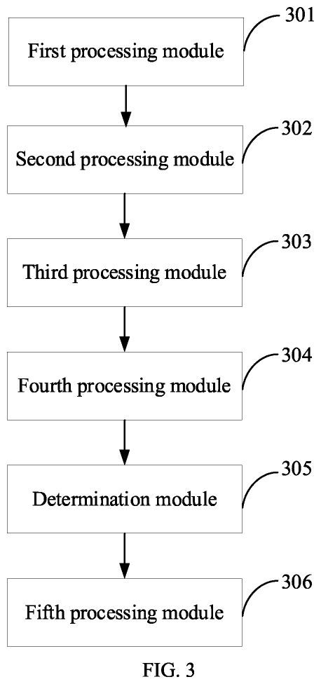

FIG. 3 is a schematic diagram of an object recommendation apparatus according to an embodiment of the present disclosure. As shown in FIG. 3, the object recommendation apparatus includes a first processing module 301, a second processing module 302, a third processing module 303, a fourth processing module 304, a determination module 305, and a fifth processing module 306.

The first processing module 301 is configured to process attribute data corresponding to a to-be-recommended object and user-side data through a large language model, respectively, to obtain extended data corresponding to the to-be-recommended object and user preference data.

The second processing module 302 is configured to perform text encoding processing on the extended data corresponding to the to-be-recommended object and the user preference data, respectively, to obtain an extended vector corresponding to the to-be-recommended object and a user preference vector.

The third processing module 303 is configured to process the extended vector corresponding to the to-be-recommended object and the user preference vector based on a gating mechanism, respectively, to obtain a gating vector corresponding to the extended vector and a gating vector corresponding to the user preference vector.

The fourth processing module 304 is configured to perform spatial alignment processing on the gating vector corresponding to the extended vector and the gating vector corresponding to the user preference vector, respectively, to obtain a target extended vector corresponding to the to-be-recommended object and a target user preference vector.

The determination module 305 is configured to determine a recommendation score corresponding to the to-be-recommended object based on the user-side data, the attribute data corresponding to the to-be-recommended object, historical interaction context data corresponding to the to-be-recommended object, the target user preference vector, and the target extended vector corresponding to the to-be-recommended object.

The fifth processing module 306 is configured to determine target object data based on the recommendation score corresponding to the to-be-recommended object and a predetermined recommendation score threshold, and transmit the target object data to a target terminal device, to display the target object data on a current graphical user interface of the target terminal device.

With the technical solution according to the embodiments of the present disclosure, by performing the text generation processing on the attribute data corresponding to the to-be-recommended object and the user-side data through the large language model, respectively, it is possible to obtain the user preference data containing the user preference information by processing the user-side data, and to obtain the extended data corresponding to the to-be-recommended object and containing the relevant information of the to-be-recommended object by processing the attribute data corresponding to the to-be-recommended object. Further, the text encoding processing may be performed on the extended data corresponding to the to-be-recommended object and the user preference data to obtain the extended vector corresponding to the to-be-recommended object and the user preference vector. The gating processing may be performed on the extended vector corresponding to the to-be-recommended object and the user preference vector, respectively, to obtain the gating vector corresponding to the extended vector and the gating vector corresponding to the user preference vector. The spatial alignment processing may be performed on the gating vector corresponding to the extended vector and the gating vector corresponding to the user preference vector, respectively, to map the gating vector corresponding to the extended vector and the gating vector corresponding to the user preference vector to the object recommendation space for data alignment, obtaining the target extended vector corresponding to the to-be-recommended object and the target user preference vector. The recommendation score corresponding to the to-be-recommended object is determined based on the user-side data, the attribute data corresponding to the to-be-recommended object, the historical interaction context data corresponding to the to-be-recommended object, the target user preference vector, and the target extended vector corresponding to the to-be-recommended object. Subsequently, the target object data may be determined based on the recommendation score corresponding to the to-be-recommended object and the predetermined recommendation score threshold, and be transmitted to the current graphical user interface of the target terminal device for display. In this way, the matching accuracy between the user preference information and the attribute information of the to-be-recommended object is improved. The flexibility and adaptability of data processing are enhanced. The correlation and accuracy of the vector representation are improved through the gating mechanism and the spatial alignment processing. The personalization and precision of the recommendation result are enhanced.

In some embodiments, the first processing module 301 is configured to: process the user-side data based on a predetermined preference generation template to obtain user-side templated data; process the attribute data corresponding to the to-be-recommended object based on a predetermined extension generation template to obtain templated attribute data corresponding to the to-be-recommended object; and process the templated attribute data corresponding to the to-be-recommended object and the user-side templated data through the large language model, respectively, to obtain the extended data corresponding to the to-be-recommended object and the user preference data.

In some embodiments, the determination module 305 is configured to: perform splicing processing on the target extended vector corresponding to the to-be-recommended object and the target user preference vector to obtain a recommendation enhancement vector; perform feature extraction processing on the user-side data, the attribute data corresponding to the to-be-recommended object, and the historical interaction context data corresponding to the to-be-recommended object to obtain a user-side vector, an attribute vector corresponding to the to-be-recommended object, and a historical interaction context vector corresponding to the to-be-recommended object; perform vector merging processing on the recommendation enhancement vector, the user-side vector, the attribute vector corresponding to the to-be-recommended object, and the historical interaction context vector corresponding to the to-be-recommended object to obtain a target vector corresponding to the to-be-recommended object; and determine the recommendation score corresponding to the to-be-recommended object based on the target vector corresponding to the to-be-recommended object.

In some embodiments, the determining the recommendation score corresponding to the to-be-recommended object based on the target vector corresponding to the to-be-recommended object includes: performing flattening processing on the target vector corresponding to the to-be-recommended object to obtain a target low-dimensional vector corresponding to the to-be-recommended object; performing mapping processing on the target low-dimensional vector corresponding to the to-be-recommended object through a multilayer perceptron to obtain a spatial mapping vector corresponding to the to-be-recommended object; and performing recommendation score calculation processing on the spatial mapping vector corresponding to the to-be-recommended object to obtain the recommendation score corresponding to the to-be-recommended object.

In some embodiments, the third processing module 303 is configured to: perform nonlinear transformation processing on the user preference vector to obtain a retention vector corresponding to the user preference vector; perform reset transformation processing on the retention vector corresponding to the user preference vector to obtain the gating vector corresponding to the user preference vector; perform nonlinear transformation processing on the extended vector corresponding to the to-be-recommended object to obtain a retention vector corresponding to the extended vector; and perform reset transformation processing on the retention vector corresponding to the extended vector to obtain the gating vector corresponding to the extended vector.

In some embodiments, the fourth processing module 304 is configured to: perform dimension alignment processing on the gating vector corresponding to the extended vector and the gating vector corresponding to the user preference vector, respectively, to obtain a same-dimension vector corresponding to the extended vector and a same-dimension vector corresponding to the user preference vector and; perform spatial transformation processing on the same-dimension vector corresponding to the extended vector and the same-dimension vector corresponding to the user preference vector to obtain the target extended vector corresponding to the to-be-recommended object and the target user preference vector.

In some embodiments, the performing the spatial transformation processing on the same-dimension vector corresponding to the extended vector and the same-dimension vector corresponding to the user preference vector, respectively, to obtain the target extended vector corresponding to the to-be-recommended object and the target user preference vector includes: performing spatial rotation processing on the same-dimension vector corresponding to the user preference vector to obtain a spatial matching vector corresponding to the user preference vector; performing weight matching processing on the same-dimension vector corresponding to the extended vector to obtain a weighted vector corresponding to the extended vector; and performing alignment processing on the weighted vector corresponding to the extended vector and the spatial matching vector corresponding to the user preference vector to obtain the target extended vector corresponding to the to-be-recommended object and the target user preference vector.

It should be understood that numerical values of sequence numbers of respective steps in the above embodiments do not indicate an order of execution. The order of execution of respective processes should be determined by functions and internal logics of the processes, and should not constitute any limitation on an implementation process of the embodiments of the present disclosure.

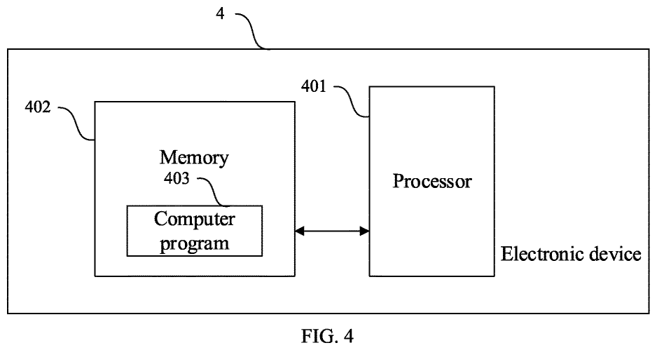

FIG. 4 is a schematic diagram of an electronic device 4 according to an embodiment of the present disclosure. As shown in FIG. 4, the electronic device 4 in this embodiment includes: a processor 401, a memory 402, and a computer program 403 stored in the memory 402 and executable on the processor 401. The processor 401, when executing the computer program 403, implements the steps in the above method embodiments. Alternatively, the processor 401, when executing the computer program 403, implements functions of each module/unit in the above apparatus embodiments.

The electronic device 4 may be an electronic device such as a desktop computer, a notebook, a palmtop computer, or a cloud server. The electronic device 4 may include, but is not limited to, the processor 401 and the memory 402. Those skilled in the art may understand that FIG. 4 is merely an example of the electronic device 4 and does not constitute a limitation on the electronic device 4. The electronic device 4 may include more or fewer components than those shown in the drawings, or different components.

The processor 401 may be a Central Processing Unit (CPU), or it may be another general-purpose processor, a Digital Signal Processor (DSP), an Application Specific Integrated Circuit (ASIC), a Field-Programmable Gate Array (FPGA), or other programmable logic devices, a discrete gate or a transistor logic device, a discrete hardware component, etc.

The memory 402 may be an internal storage unit of the electronic device 4, such as a hard disk or a memory of the electronic device 4. The memory 402 may also be an external storage device of the electronic device 4, such as a plug-in hard disk, a Smart Media Card (SMC), a Secure Digital (SD) card, a Flash Card, or the like equipped on the electronic device 4. The memory 402 may also include both an internal storage unit and an external storage device of the electronic device 4. The memory 402 is configured to store a computer program and other programs and data required by the electronic device.

Those skilled in the art may clearly understand that, for convenience and conciseness of description, the divisions of the above functional units and modules are merely illustrative. In practical applications, the above functions may be allocated to different functional units and modules for implementation as required. That is, an internal structure of the above apparatus is divided into different functional units or modules to complete all or part of the functions described above. The functional units and modules in the embodiments may be integrated into one processing unit, or each unit may exist physically alone, or two or more units may be integrated into one unit. The integrated units may be implemented in a form of hardware, or in a form of a software functional unit.

If the integrated modules/units are realized in a form of functional software units and are sold or used as separate products, the integrated modules/units may be stored in a computer-readable storage medium. Based on this understanding, all or part of the processes in the above method embodiments of the present disclosure may also be implemented by relevant hardware instructed by a computer program. The computer program may be stored in a computer-readable storage medium. When the computer program is executed by the processor, steps of the above method embodiments may be implemented. The computer program may include computer program codes. The computer program codes may be in a form of source codes, object codes, an executable file, or some intermediate forms, etc. The computer-readable medium may include any entity or device capable of carrying the computer program codes, a recording medium, a USB disk, a mobile hard disk, a magnetic disk, an optical disk, a computer memory, a Read-Only Memory (ROM), a Random Access Memory (RAM), an electric carrier signal, a telecommunications signal, and a software distribution medium, etc.

The above embodiments are only used to illustrate, rather than to limit, the technical solutions of the present disclosure. Although the present disclosure has been described in detail with reference to the above embodiments, those skilled in the art should understand that modifications may be made to the technical solutions described in the above embodiments, or equivalent replacements may be made to some of the technical features of the technical solutions described in the above embodiments. However, these modifications or replacements do not cause the essence of corresponding technical solutions to deviate from the spirit and scope of the technical solutions of the embodiments of the present disclosure, and shall be included in the scope of the present disclosure.

What is claimed is:

1. An object recommendation method, comprising:
processing attribute data corresponding to a to-be-recommended object and user-side data through a large language model, respectively, to obtain extended data corresponding to the to-be-recommended object and user preference data;
performing text encoding processing on the extended data corresponding to the to-be-recommended object and the user preference data, respectively, to obtain an extended vector corresponding to the to-be-recommended object and a user preference vector;
processing the extended vector corresponding to the to-be-recommended object and the user preference vector based on a gating mechanism, respectively, to obtain a gating vector corresponding to the extended vector and a gating vector corresponding to the user preference vector;
performing spatial alignment processing on the gating vector corresponding to the extended vector and the gating vector corresponding to the user preference vector, respectively, to obtain a target extended vector corresponding to the to-be-recommended object and a target user preference vector;
determining a recommendation score corresponding to the to-be-recommended object based on the user-side data, the attribute data corresponding to the to-be-recommended object, historical interaction context data corresponding to the to-be-recommended object, the target user preference vector, and the target extended vector corresponding to the to-be-recommended object; and
determining target object data based on the recommendation score corresponding to the to-be-recommended object and a predetermined recommendation score threshold, and transmitting the target object data to a target terminal device, to display the target object data on a current graphical user interface of the target terminal device.

2. The object recommendation method according to claim 1, wherein said processing the attribute data corresponding to the to-be-recommended object and the user-side data through the large language model, respectively, to obtain the extended data corresponding to the to-be-recommended object and the user preference data comprises:
processing the user-side data based on a predetermined preference generation template to obtain user-side templated data;
processing the attribute data corresponding to the to-be-recommended object based on a predetermined extension generation template to obtain templated attribute data corresponding to the to-be-recommended object; and
processing the templated attribute data corresponding to the to-be-recommended object and the user-side templated data through the large language model, respectively, to obtain the extended data corresponding to the to-be-recommended object and the user preference data.

3. The object recommendation method according to claim 1, wherein said determining the recommendation score corresponding to the to-be-recommended object based on the user-side data, the attribute data corresponding to the to-be-recommended object, the historical interaction context data corresponding to the to-be-recommended object, the target user preference vector, and the target extended vector corresponding to the to-be-recommended object comprises:
performing splicing processing on the target extended vector corresponding to the to-be-recommended object and the target user preference vector to obtain a recommendation enhancement vector;
performing feature extraction processing on the user-side data, the attribute data corresponding to the to-be-recommended object, and the historical interaction context data corresponding to the to-be-recommended object, respectively, to obtain a user-side vector, an attribute vector corresponding to the to-be-recommended object, and a historical interaction context vector corresponding to the to-be-recommended object;
performing vector merging processing on the recommendation enhancement vector, the user-side vector, the attribute vector corresponding to the to-be-recommended object, and the historical interaction context vector corresponding to the to-be-recommended object to obtain a target vector corresponding to the to-be-recommended object; and
determining the recommendation score corresponding to the to-be-recommended object based on the target vector corresponding to the to-be-recommended object.

4. The object recommendation method according to claim 3, wherein said determining the recommendation score corresponding to the to-be-recommended object based on the target vector corresponding to the to-be-recommended object comprises:
performing flattening processing on the target vector corresponding to the to-be-recommended object to obtain a target low-dimensional vector corresponding to the to-be-recommended object;
performing mapping processing on the target low-dimensional vector corresponding to the to-be-recommended object through a multilayer perceptron to obtain a spatial mapping vector corresponding to the to-be-recommended object; and
performing recommendation score calculation processing on the spatial mapping vector corresponding to the to-be-recommended object to obtain the recommendation score corresponding to the to-be-recommended object.

5. The object recommendation method according to claim 1, wherein said processing the extended vector corresponding to the to-be-recommended object and the user preference vector based on the gating mechanism, respectively, to obtain the gating vector corresponding to the extended vector and the gating vector corresponding to the user preference vector comprises:
performing nonlinear transformation processing on the user preference vector to obtain a retention vector corresponding to the user preference vector;
performing reset transformation processing on the retention vector corresponding to the user preference vector to obtain the gating vector corresponding to the user preference vector;
performing nonlinear transformation processing on the extended vector corresponding to the to-be-recommended object to obtain a retention vector corresponding to the extended vector; and
performing reset transformation processing on the retention vector corresponding to the extended vector to obtain the gating vector corresponding to the extended vector.

6. The object recommendation method according to claim 1, wherein said performing the spatial alignment processing on the gating vector corresponding to the extended vector and the gating vector corresponding to the user preference vector, respectively, to obtain the target extended vector corresponding to the to-be-recommended object and the target user preference vector comprises:
performing dimension alignment processing on the gating vector corresponding to the extended vector and the gating vector corresponding to the user preference vector, respectively, to obtain a same-dimension vector corresponding to the extended vector and a same-dimension vector corresponding to the user preference vector; and
performing spatial transformation processing on the same-dimension vector corresponding to the extended vector and the same-dimension vector corresponding to the user preference vector, respectively, to obtain the target extended vector corresponding to the to-be-recommended object and the target user preference vector.

7. The object recommendation method according to claim 6, wherein said performing the spatial transformation processing on the same-dimension vector corresponding to the extended vector and the same-dimension vector corresponding to the user preference vector, respectively, to obtain the target extended vector corresponding to the to-be-recommended object and the target user preference vector comprises:
performing spatial rotation processing on the same-dimension vector corresponding to the user preference vector to obtain a spatial matching vector corresponding to the user preference vector;
performing weight matching processing on the same-dimension vector corresponding to the extended vector to obtain a weighted vector corresponding to the extended vector; and
performing alignment processing on the weighted vector corresponding to the extended vector and the spatial matching vector corresponding to the user preference vector to obtain the target extended vector corresponding to the to-be-recommended object and the target user preference vector.

8. An electronic device, comprising:
a memory;
a processor; and
a computer program stored in the memory and executable on the processor,
wherein the processor is configured to, when executing the computer program:
process attribute data corresponding to a to-be-recommended object and user-side data through a large language model, respectively, to obtain extended data corresponding to the to-be-recommended object and user preference data;
perform text encoding processing on the extended data corresponding to the to-be-recommended object and the user preference data, respectively, to obtain an extended vector corresponding to the to-be-recommended object and a user preference vector;
process the extended vector corresponding to the to-be-recommended object and the user preference vector based on a gating mechanism, respectively, to obtain a gating vector corresponding to the extended vector and a gating vector corresponding to the user preference vector;
perform spatial alignment processing on the gating vector corresponding to the extended vector and the gating vector corresponding to the user preference vector, respectively, to obtain a target extended vector corresponding to the to-be-recommended object and a target user preference vector;
determine a recommendation score corresponding to the to-be-recommended object based on the user-side data, the attribute data corresponding to the to-be-recommended object, historical interaction context data corresponding to the to-be-recommended object, the target user preference vector, and the target extended vector corresponding to the to-be-recommended object; and
determine target object data based on the recommendation score corresponding to the to-be-recommended object and a predetermined recommendation score threshold, and transmitting the target object data to a target terminal device, to display the target object data on a current graphical user interface of the target terminal device.

9. The electronic device according to claim 8, wherein the processor is configured to, when executing the computer program:
process the user-side data based on a predetermined preference generation template to obtain user-side templated data;
process the attribute data corresponding to the to-be-recommended object based on a predetermined extension generation template to obtain templated attribute data corresponding to the to-be-recommended object; and
process the templated attribute data corresponding to the to-be-recommended object and the user-side templated data through the large language model, respectively, to obtain the extended data corresponding to the to-be-recommended object and the user preference data.

10. The electronic device according to claim 8, wherein the processor is configured to, when executing the computer program:
perform splicing processing on the target extended vector corresponding to the to-be-recommended object and the target user preference vector to obtain a recommendation enhancement vector;
perform feature extraction processing on the user-side data, the attribute data corresponding to the to-be-recommended object, and the historical interaction context data corresponding to the to-be-recommended object, respectively, to obtain a user-side vector, an attribute vector corresponding to the to-be-recommended object, and a historical interaction context vector corresponding to the to-be-recommended object;
perform vector merging processing on the recommendation enhancement vector, the user-side vector, the attribute vector corresponding to the to-be-recommended object, and the historical interaction context vector corresponding to the to-be-recommended object to obtain a target vector corresponding to the to-be-recommended object; and
determine the recommendation score corresponding to the to-be-recommended object based on the target vector corresponding to the to-be-recommended object.

11. The electronic device according to claim 10, wherein the processor is configured to, when executing the computer program:
perform flattening processing on the target vector corresponding to the to-be-recommended object to obtain a target low-dimensional vector corresponding to the to-be-recommended object;
perform mapping processing on the target low-dimensional vector corresponding to the to-be-recommended object through a multilayer perceptron to obtain a spatial mapping vector corresponding to the to-be-recommended object; and
perform recommendation score calculation processing on the spatial mapping vector corresponding to the to-be-recommended object to obtain the recommendation score corresponding to the to-be-recommended object.

12. The electronic device according to claim 8, wherein the processor is configured to, when executing the computer program:
perform nonlinear transformation processing on the user preference vector to obtain a retention vector corresponding to the user preference vector;
perform reset transformation processing on the retention vector corresponding to the user preference vector to obtain the gating vector corresponding to the user preference vector;
perform nonlinear transformation processing on the extended vector corresponding to the to-be-recommended object to obtain a retention vector corresponding to the extended vector; and
perform reset transformation processing on the retention vector corresponding to the extended vector to obtain the gating vector corresponding to the extended vector.

13. The electronic device according to claim 8, wherein the processor is configured to, when executing the computer program:
perform dimension alignment processing on the gating vector corresponding to the extended vector and the gating vector corresponding to the user preference vector, respectively, to obtain a same-dimension vector corresponding to the extended vector and a same-dimension vector corresponding to the user preference vector; and
perform spatial transformation processing on the same-dimension vector corresponding to the extended vector and the same-dimension vector corresponding to the user preference vector, respectively, to obtain the target extended vector corresponding to the to-be-recommended object and the target user preference vector.

14. The electronic device according to claim 13, wherein the processor is configured to, when executing the computer program:
perform spatial rotation processing on the same-dimension vector corresponding to the user preference vector to obtain a spatial matching vector corresponding to the user preference vector;
perform weight matching processing on the same-dimension vector corresponding to the extended vector to obtain a weighted vector corresponding to the extended vector; and
perform alignment processing on the weighted vector corresponding to the extended vector and the spatial matching vector corresponding to the user preference vector to obtain the target extended vector corresponding to the to-be-recommended object and the target user preference vector.

15. A non-transitory readable storage medium, storing a computer program, wherein the computer program, when executed by a processor, implements the following steps:
processing attribute data corresponding to a to-be-recommended object and user-side data through a large language model, respectively, to obtain extended data corresponding to the to-be-recommended object and user preference data;
performing text encoding processing on the extended data corresponding to the to-be-recommended object and the user preference data, respectively, to obtain an extended vector corresponding to the to-be-recommended object and a user preference vector;
processing the extended vector corresponding to the to-be-recommended object and the user preference vector based on a gating mechanism, respectively, to obtain a gating vector corresponding to the extended vector and a gating vector corresponding to the user preference vector;
performing spatial alignment processing on the gating vector corresponding to the extended vector and the gating vector corresponding to the user preference vector, respectively, to obtain a target extended vector corresponding to the to-be-recommended object and a target user preference vector;
determining a recommendation score corresponding to the to-be-recommended object based on the user-side data, the attribute data corresponding to the to-be-recommended object, historical interaction context data corresponding to the to-be-recommended object, the target user preference vector, and the target extended vector corresponding to the to-be-recommended object; and
determining target object data based on the recommendation score corresponding to the to-be-recommended object and a predetermined recommendation score threshold, and transmitting the target object data to a target terminal device, to display the target object data on a current graphical user interface of the target terminal device.
